(19) United States
(12) Patent Application Publication
(10) Pub. No.: US 2016/0255891 A1
(43) Pub. Date: Sep. 8, 2016

(54) METHOD OF PRODUCING MATERIAL FOR PROTECTIVE GARMENT, MATERIAL FOR PROTECTIVE GARMENT, AND PROTECTIVE GARMENT

(71) Applicant: Gun Ei Chemical Industry Co., Ltd., Takasaki-shi (JP)

(72) Inventors: Masaru KIMURA, Takasaki-shi (JP); Shinichi MURATA, Takasaki-shi (JP); Akiyuki KOJIMA, Takasaki-shi (JP)

(73) Assignee: Gun Ei Chemical Industry Co., Ltd., Takasaki-shi (JP)

(21) Appl. No.: 14/637,956

(22) Filed: Mar. 4, 2015

(51) Int. Cl. A41D 31/00; B01J 20/28; B01J 20/20; B01J 20/30

(52) U.S. Cl. CPC A41D 31/0011; B01J 20/3007; B01J 20/28033; B01J 20/28035; B01J 20/20

(57) ABSTRACT

A method of producing a material for protective garment includes step of sheet-forming activated carbon fiber sheet using activated carbon fibers in which a phenolic resin fiber is used as a precursor and a step of reinforcing the activated carbon fiber sheet by interweaving a thread onto the activated carbon fiber sheet.

### FIELD OF THE INVENTION

The present invention relates to a method of producing a material for a protective garment provided with an activated carbon fiber sheet.

### BACKGROUND OF THE INVENTION

In the related art, protective garments provided with an adsorption layer including an activated carbon has been proposed as a protective garment which protects a human body from hazardous substances which are absorbed through the skin and give adverse effects on a human body, particularly gaseous hazardous substance.

As an activated carbon used for the adsorption layer, when being roughly classified by shapes, a granular activated carbon (a crushed carbon, a molded carbon, a spherical activated carbon, or the like) and an activated carbon fiber (a fibrous activated carbon) are included.

The granular activated carbon is generally cheap and also has a wide range of adsorption of the hazardous substance, and thus is widely used. However, the granular activated carbon is inferior in adsorption performance of the hazardous substance including an adsorption rate of the hazardous substance or the like, which is an important factor for using the protective garment, compared to the activated carbon fiber.

On this point, in a case of using the granular activated carbon, a measure for improving adsorption performance by increasing thickness of the layer to apply larger amount of the granular activated carbon per unit area is taken. However, if the adsorption layer becomes thicker, the protective garment becomes heavier. In addition, the air permeability deteriorates and when a person wears the protective garment for a long time, heat accumulation problem inside the protective garment is easily caused. Furthermore, in order to apply the granular activated carbon to the protective garment, it is essential to form the granular activated carbon into a sheet; however, since the granular activated carbon sheet needs to have sufficient strength to maintain a sheet shape, the obtained sheet becomes rigid. Therefore, in a case where this rigid sheet is used for the adsorption layer of the protective garment, wearing comfort of the protective garment is very bad.

On the other hand, since the adsorption performance of hazardous substances of the activated carbon fiber is higher than the granular activated carbon, it is easy to reduce the weight of the protective garment. In addition, since the activated carbon fiber formed into a sheet has great flexibility, compared to the granular activated carbon formed into a sheet, wearing comfort is better when used for the protective garment.

However, to obtain higher performance of activated carbon fiber, higher activation which gives damage on activated carbon fiber is needed. Therefore, mechanical strength becomes weak, and thus it becomes difficult to form the activated carbon fiber directly into a sheet. Therefore, in a case of producing the activated carbon fiber sheet which has high adsorption performance, it is necessary to manufacture woven fabric or such sheet from spinning yarn made of precursor fibers, and apply carbonization and activation process on it. In addition, since the activated carbon fiber is very expensive, compared to the granular activated carbon and the producing process becomes complicated in this way, and thus the cost required for a raw material and processing is high, as to the activated carbon fiber formed into a sheet and the protective garment using the same, the price becomes higher than a case of using the granular activated carbon. For these reasons, as an activated carbon used for the protective garment, the granular activated carbon is mainly used.

For processing a fiber into a sheet, a papermaking technique is generally known as a simple method. However, when the fiber which is a precursor of the activated carbon fiber is processed into a sheet before carbonizing and activating, a binder disappears due to thermal decomposition and the strength of the sheet is not sufficient, which results in the sheet not withstanding a practical use.

In case of making a paper from the activated carbon fiber directly, it is needed to ensure the mechanical strength capable of the process. As a result, only the activated carbon fiber with less degree of the activation treatment is available, and the problem of the adsorption performance remains.

In Japanese Patent No. 3908234, a protective material utilizing two adsorption materials which are a granular activated carbon (a spherical activated carbon) and an activated carbon fiber is proposed. However, the protective material is just two layers superposed by each layer, so it has not reached to a fundamental solution yet.

In Japanese Unexamined Patent Application, First Publication No. H11-333234, in order to reinforce the strength and enhance the processability without deteriorating the performance as a filter of an activated carbon fiber mat, an activated carbon filter with the activated carbon fiber mat stitched with a thread, and an activated carbon filter with the activated carbon fiber mat and the sheets of a net-like tissue laminated on one face or both faces stitched with a thread and integrated are proposed.

However, the activated carbon fiber mat in this literature, which is produced by carbonizing and activating a precursor, is complicated to produce, therefore the cost required for a raw material and processing increases.

### SUMMARY OF THE INVENTION

An object of the present invention is to provide a production method with high productivity which enables to produce a material for a protective garment which has high performance of adsorbing hazardous substances and a mechanical strength and gives comfortableness when used as a protective garment.

Another object of the present invention is to provide a material for a protective garment with high adsorption performance of a hazardous substance, mechanical strength and gives comfortableness when used as a protective garment.

Still another object of the present invention is to provide a protective garment which can prevent a hazardous substance from permeation and gives comfortableness.

The first aspect of the present invention is a method of producing a material for a protective garment provided with an activated carbon fiber sheet, including a step of sheet-forming an activated carbon fiber sheet using an activated carbon fiber with a phenolic resin fiber used as a precursor and a step of reinforcing the activated carbon fiber sheet by interweaving a thread into the activated carbon fiber sheet.

The second aspect of the present invention is a method of producing a material for a protective garment provided with an activated carbon fiber sheet, including a step of sheet-forming an activated carbon fiber sheet using an activated carbon fiber with a phenolic resin fiber used as a precursor and a step of reinforcing the activated carbon fiber sheet by superposing fabrics on either one or both of a first face and a second face of the activated carbon fiber sheet to set a laminate and interweaving a thread into the laminate.

In the method of producing a material for a protective garment of the first aspect described above, it is preferable that the average fiber diameter of the activated carbon fiber is from 2 μm to 50 μM and the average fiber length of the activated carbon fiber is from 1 mm to 100 mm.

In the method of producing a material for a protective garment of the second aspect described above, it is preferable that the average fiber diameter of the activated carbon fiber is from 2 μm to 50 μm and the average fiber length of the activated carbon fiber is from 1 mm to 100 mm.

The third aspect of the present invention is a material for a protective garment produced by the method of producing a material for a protective garment of the first aspect described above.

The fourth aspect of the present invention is a material for a protective garment produced by the method of producing a material for a protective garment of the second aspect described above.

The fifth aspect of the present invention is a protective garment using the material for a protective garment of the third aspect described above.

The sixth aspect of the present invention is a protective garment using the material for a protective garment of the fourth aspect described above.

### BRIEF DESCRIPTION OF THE DRAWINGS

FIG. 1 is a schematic plane view showing a material for a protective garment produced in first embodiment of a method of producing a material for a protective garment of the present invention.

FIG. 2 is a partial schematic cross-section view for II-II of a material for a protective garment shown in FIG. 1.

FIG. 3 is a partial schematic cross-section view showing a material for a protective garment produced in second embodiment of a method of producing a material for a protective garment of the present invention.

### DETAILED DESCRIPTION OF THE INVENTION

### First Embodiment

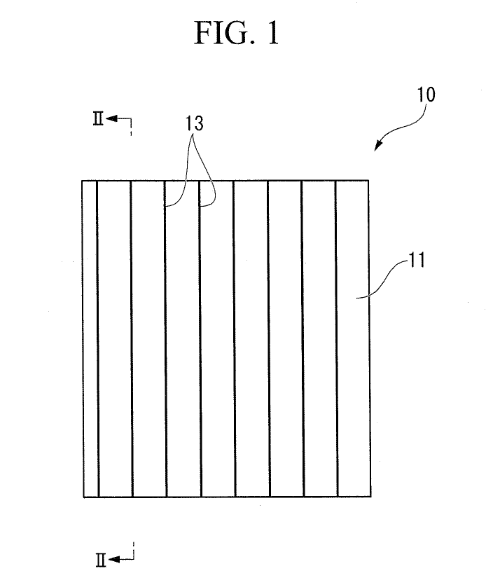

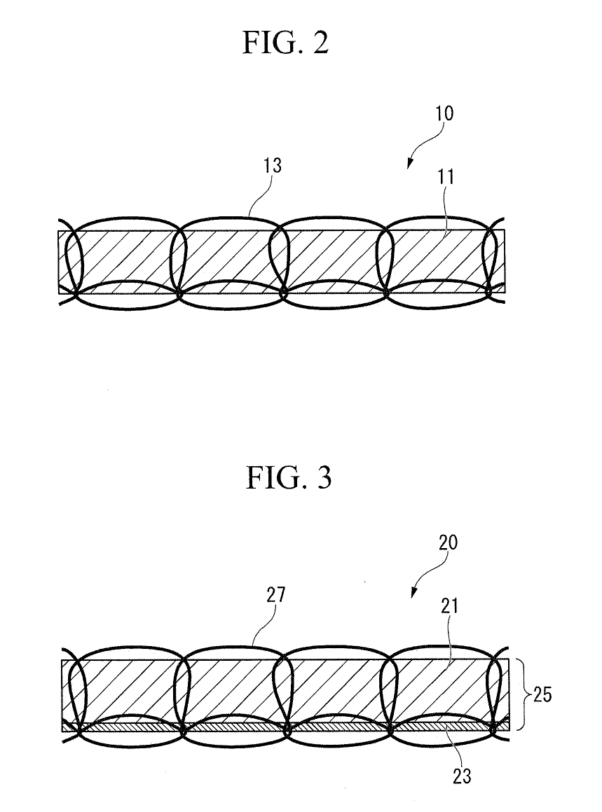

FIG. 1 is a schematic plane view showing a material for a protective garment produced in first embodiment of a method of producing a material for a protective garment of the present invention. FIG. 2 is a partial schematic cross-section view for II-II of a material for a protective garment shown in FIG. 1.

A material for a protective garment 10 in the present embodiment is provided with an activated carbon fiber sheet 11 and a thread 13 interwoven into the activated carbon fiber sheet 11.

The activated carbon fiber sheet 11 is formed from an activated carbon fiber with the phenolic resin fiber used as a precursor.

Stitch patterns are formed on a first face and a second face of the activated carbon fiber sheet 11 respectively by the thread 13. The stitch pattern in the present embodiment is a stitch pattern in which multiple straight lines are arrayed in parallel as shown in FIG. 1.

As for the material of a protective garment 10, the activated carbon fiber sheet 11 is reinforced by the thread 13.

The material for a protective garment 10 can be produced by a production method including a step of sheet-forming the activated carbon fiber sheet 11 using the activated carbon fiber with the phenolic resin fiber used as a precursor (hereinafter, also referred to as a “step (1-1)”) and a step of reinforcing the activated carbon fiber sheet 11 by interweaving the thread 13 into the activated carbon fiber sheet 11 (hereinafter, also referred to as a “step (1-2)”).

<Activated Carbon Fiber>

The activated carbon fiber is a fiber with the phenolic resin fiber used as a precursor. That is, it is a fiber in which the phenolic resin fiber is carbonized and activated.

For the activated carbon fiber with the phenolic resin fiber used as a precursor, the mechanical strength is higher compared with a polyacrylonitrile-based or a pitch-based activated carbon fiber which is widely used and it is able to form into a sheet directly.

The average fiber diameter (the average filament diameter) of the activated carbon fiber is preferably from 2 μm to 50 μm and more preferably from 5 μm to 30 μm.

The average fiber length of the activated carbon fiber is preferably from 1 mm to 100 mm and more preferably from 2 mm to 10 mm.

The BET specific surface area of the activated carbon fiber is preferably from 500 m²/g to 3,000 m²/g and more preferably from 1,000 m²/g to 2,000 m²/g. When the BET specific surface area is equal to or greater than a lower limit value of the range described above, the adsorption performance becomes high, and when the BET specific surface area is equal to or less than an upper limit value of the range described above, the sheet strength becomes higher.

The BET specific surface area is a specific surface area measured by a BET method by a nitrogen adsorption under a condition of a liquid nitrogen temperature by using pore size analyzers.

As an activated carbon fiber, an activated carbon fiber on the market or an activated carbon fiber produced by a publicly-known production method can be used.

The activated carbon fiber is produced, for example, by a method of carbonizing and activating the phenolic resin fiber and cutting into a proper fiber length as necessary, or other known method.

As a phenolic resin fiber, for example, a phenolic resin fiber which phenolic resin is melt spun and cured, can be used.

As a phenolic resin, a novolak type phenolic resin obtained by reacting phenols with aldehydes in the presence of an acid catalyst, a resol type phenolic resin obtained by reacting phenols with aldehydes in the presence of a alkaline catalyst, various kinds of modified phenolic resins, a mixture thereof, and the like can be used. As various kinds of modified phenolic resins, modified phenolic resins which a novolak type or a resol type phenolic resin is modified by a publicly-known technique such as boron modified phenolic resins, silicon modified phenolic resins, heavy metal modified phenolic resins, nitrogen modified phenolic resins, sulfur modified phenolic resins, oil modified phenolic resins, or rosin modified phenolic resins, are included. These phenolic resins can be used alone or in combination of two or more kinds thereof.

An additive agent can be added to the phenolic resin, as necessary. As additive agents, publicly-known additive agents for phenolic resin can be used for the phenolic resin fiber.

As a spinning method, a publicly-known appropriate method can be selected and wet spinning, dry spinning, dry-wet spinning, melt spinning, gel spinning, liquid crystal spinning, and other spinning method are included. Among those, melt spinning is preferable because of the simplicity of the apparatus and its economic advantages.

As a curing method, a publicly-known method can be used. For example, as a curing method in a case of using a novolak type phenolic resin, a method in which a treatment liquid containing aldehydes such as formaldehyde and a catalyst comes into contact with fibers and applies heat can be used. As a curing method in case of using a resol type phenolic resin as a raw material, heat treatment method can be used.

As a carbonization method of the phenolic resin fiber, a publicly-known conventional method can be used. For example, a method of heating in presence of an inert gas is included. As an inert gas which can be used when carbonizing, are nitrogen, argon, and such inert gases are included. The heating temperature is preferably from 600° C. to 1,200° C. and more preferably 800° C. to 1,000° C.

As an activation method of the carbonized phenolic resin fiber, a publicly-known method in the related art can be used. In particular, a gas activation method which in contact with water vapor, carbon dioxide (combustion gas), oxygen (air), or other oxidizing gases at a temperature from 700° C. to 1,200° C.; a chemical activation method of impregnating zinc chloride, phosphate salts, or alkali metal compounds such as potassium hydroxide or acids such as sulfuric acid, afterward, heating in an inert gas atmosphere at a temperature preferably from 300° C. to 800° C., or such chemical activation method can be used. Heating the carbonized phenolic resin fiber can be performed by a publicly-known heating apparatus such as a multistage furnace, a rotary kiln, or a fluidized bed furnace. In a case of a chemical activation method, after activation, product or impregnated chemical is able to neutralize with an acid or an alkali and removed by washing with the water or other method. Among the activation methods described above, a gas activation method is preferable and a gas activation method by water vapor is particularly preferable, from the point of view of the simplicity of no special treatment after activation is required.

<Step (1-1)>

A sheet-forming method of the activated carbon fiber sheet 11 is not particularly limited and a publicly-known wet laid nonwovens production method can be used. For example, the activated carbon fiber sheet 11 can be manufactured by preparing a slurry by mixing the activated carbon fiber, a binder, and water, uniformly spreading the slurry on a net of a papermaking machine, and dehydrating the slurry by compression and drying. As a papermaking machine, a publicly-known papermaking machine can be used. Heating and air circulation at room temperature can be applied to dry process.

As a binder, vinylons, acrylics, polyolefins, polyesters, polypropylenes, meta-aramids, para-aramids, and other binders can be used. These binders can be, for example, fibers, pulps, or other forms. These binders can be used alone or in combination of two or more kind of binders.

The slurry described above can contain other components except the activated carbon fiber and binder as necessary unless the formed sheet characteristics become inapplicable for the invention. As other components, for example, granular activated carbons, other activated carbon fibers, conductive auxiliaries, metal catalysts, clay minerals, and other slurry materials are included.

In the slurry above, the mass ratio between activated carbon fiber and the binder (activated carbon fiber:binder) is preferably from 95:5 to 50:50 and more preferably 80:20 to 70:30. When the proportion of the activated carbon fiber in total 100 of the activated carbon fiber and the binder is 50 or more, the adsorption performance becomes higher, and the proportion is 95 or less, the mechanical strength becomes higher.

In the previous slurry, the mass ratio between activated carbon fiber and granular activated carbon (activated carbon fiber:granular activated carbon) is preferably from 100:0 to 1:99 and more preferably 100:0 to 50:50. The rate of granular activated carbon decreases, the higher mechanical strength and adsorption performance can be obtained.

Areal weight of the activated carbon fiber sheet 11 is preferably from 50 g/m² to 300 g/m² and more preferably from 100 g/m² to 200 g/m². When the areal weight of the activated carbon fiber sheet 11 is a lower limit in the range described above or more, the adsorption performance and the mechanical strength of the activated carbon fiber sheet 11 become high, and when the areal weight of the activated carbon fiber sheet 11 is an upper limit in the range described above or less, wearing comfort of the protective garment becomes well.

<Step (1-2)>

In the step (1-2), the thread 13 is interwoven onto the activated carbon fiber sheet 11 to reinforce the activated carbon fiber sheet 11. Accordingly, the material for a protective garment 10 is obtained.

As the thread 13, for example, a spun yarn, a filament thread, and other kind of yarns are included.

As a material of the thread 13, for example, nylon, polyester, acrylic, viscose, cellulose, PPS, meta-aramid, para-aramid, and other kind of materials are included. Among those, in a case where the heat resistance is not required, polyester is preferable because of the price and the strength, and in a case where the heat resistance is required, any one of or both of meta-aramid and para-aramid are preferable.

The thickness of the thread 13 is preferably from 50 denier to 300 denier and more preferably from 75 denier to 200 denier. When the thickness of the thread 13 is equal to or greater than a lower limit value of the range described above, the reinforcement effect becomes better, and when the thickness of the thread 13 is equal to or less than an upper limit value in the range described above, the flexibility of the material for protective garments 10 is high.

As a method of interweaving the thread 13 onto the activated carbon fiber sheet 11, publicly-known methods can be used.

The stitch density in a wale direction of the thread 13 (in a horizontal direction in FIG. 1) is preferably from 1 tread/inch to 36 treads/inch and more preferably from 1 treads/inch to 18 treads/inch. When the stitch density in a wale direction is equal to or greater than a lower limit value of the range described above, the reinforcement effect is higher, and when the driving density in a wale direction is equal to or less than an upper limit value of the range described above, the flexibility of the material for a protective garment 10 becomes better.

The stitch length in course direction is not particularly limited; however, preferably 0.7 mm to 3.2 mm. When the stitch length in course direction is equal to or greater than a lower limit value of the range described above, the flexibility of the material for a protective garment 10 becomes better, and when the stitch length in course direction is equal to or less than an upper limit value of the range described above, the reinforcement effect becomes better.

Meanwhile, course direction means the direction of a straight line connecting the start point and end point of one stitch. In the present embodiment, all course directions of a plurality of stitches forming the stitch pattern are vertical directions in FIG. 1.

### Second Embodiment

FIG. 3 is a schematic cross-section view showing a material for a protective garment produced in second embodiment of a method of producing a material for a protective garment of the present invention.

A material for a protective garment 20 in the present embodiment is the same as the material for a protective garment 10 in the first embodiment, except that the material for a protective garment 20 has liner fabric, the liner fabric is bonded with the activated carbon fiber sheet by the thread, and thus the activated carbon fiber sheet is reinforced by the thread and the fabric.

That is, the material for a protective garment 20 in the present embodiment is provided with a laminate 25 and a thread 27 which is interwoven onto the laminate 25.

The laminate 25 is provided with an activated carbon fiber sheet 21 and a fabric 23 which is laminated on a first layer of the activated carbon fiber sheet 21. The activated carbon fiber sheet 21 is wet laid the activated carbon fiber which phenolic resin fiber is used as a precursor.

The activated carbon fiber sheet 21 is integrated with the fabric 23 by the thread 27.

The stitch patterns are respectively formed on both faces of the laminate 25 by the thread 27.

The material for a protective garment 20 can be produced by a production method comprising a step of wet laid on the activated carbon fiber sheet 21 using the activated carbon fiber in which the phenolic resin fiber is used as a precursor (hereinafter, also referred to as a “step (2-1)”) and a step of reinforcing the activated carbon fiber sheet 21 by superposing the fabric 23 on the first face of the activated carbon fiber sheet 21 to set the laminate 25 and interweaving the thread 27 onto the laminate 25 (hereinafter, also referred to as a “step (2-2)”).

The activated carbon fiber used in the present embodiment is same as the activated carbon fiber used in the first embodiment.

<Step (2-1)>

The step (2-1) can be performed in the same way as the step (1-1) of the first embodiment.

<Step (2-2)>

As the fabric 23, nonwoven fabrics, woven fabrics, knit fabrics, and other kind of fabrics are included. As nonwoven fabrics, chemical bond nonwoven fabrics, thermal bond nonwoven fabrics, needle-punched nonwoven fabrics, spun lace (hydroentangled) nonwoven fabrics, and other kind of nonwoven fabrics are included. As woven fabrics, plain weave, twill weave, or satin weave and other kind of woven fabrics are included. As knit fabrics, plain knit, circular knit, or warp knit and other kind of knit fabrics are included. Among those, nonwoven fabrics are preferable because of view of the cost and the air permeability.

As a material of the fabric 23, nylon, polyester, acrylic, viscose, cellulose, PPS, meta-aramid, para-aramid, and other fibers are included. Among those, nylon, acrylic, and polyester are preferable because of view of the cost and the abrasion resistance.

The areal weight of the fabric 23 is preferably from 10 g/m² to 300 g/m² and more preferably from 20 g/m² to 100 g/m². When the areal weight of the fabric 23 is equal to or greater than a lower limit value of the range described above, the reinforcement effect and the abrasion resistance become higher, and when the areal weight of the fabric 23 is equal to or less than an upper limit value of the range described above, the air permeability becomes higher.

The fabric 23 is superposed on the first face of the activated carbon fiber sheet 11 to set the laminate 25 and the thread 27 is interwoven onto the laminate 25 to reinforce the activated carbon fiber sheet 11. Accordingly, the material for a protective garment 20 is obtained.

Interweaving the thread 27 onto the laminate 25 can be performed in the same way as interweaving the thread 13 onto the activated carbon fiber sheet 11 in the step (1-2) in the first embodiment.

Hereinbefore, as the method of producing the activated carbon fiber sheet of the present invention, a description was given with reference to the embodiments, however, the present invention is not limited to the embodiments described above. The individual configurations, combinations in the embodiments described above are only examples and additions, omissions, substitutions, and other changes to the configuration are available unless the fabric characteristics become inapplicable for the invention.

For example, in FIG. 1, as the stitch pattern which a plurality of straight lines by the thread are arrayed in parallel on a surface of the material for a protective garment, is shown; however, the present invention is not limited thereto, and the stitch pattern can be substituted by other stitch patterns. As other stitch patterns, for example, a plurality of zigzag lines are arrayed in parallel so as not to be lapped over each other, lattice stitch pattern, chain pattern, and other stitch patterns are included.

In the second embodiment, as an example, a laminate in which a fabric is laminated on the first face of the activated carbon fiber sheet, was shown; however, the thread can be also interwoven onto the laminate in which the fabric is laminated on the second face of the activated carbon fiber sheet or the laminate in which the fabrics are laminated on both the first face and the second face of the activated carbon fiber sheet. In a case where the fabrics are laminated on both the first face and the second face, the fabrics respectively laminated on the first face and second face of the activated carbon fiber sheet can be same fabric or different fabric from each other.

The material for a protective garment produced by the method of producing the material for a protective garment of the present invention is used to produce the protective garment. As a method of producing the protective garment using the material for a protective garment, a publicly-known method can be utilized.

To produce the protective garment, the material for a protective garment can be subjected to processing such as cutting, bonding of a lining, bonding of an outer shell fabric, or sewing. In a case where the material for a protective garment is provided with the fabrics which are laminated on any one of or both the first face and the second face of the activated carbon fiber sheet, the lining or the outer shell fabric further laminate on the fabric is not necessary.

The material for a protective garment produced by the method of producing the material for a protective garment of the present invention has high adsorption performance of the hazardous substances, for example, hazardous substance gases which is absorbed through the skin and affects an adverse effect on a human body. Therefore, the protective garment using the above material for a protective garment can effectively prevent the hazardous substance from permeation.

The material for a protective garment has high mechanical strength. Therefore, it is possible to independently handle the material for a protective garment and the material for a protective garment is easily processed into protective garments. In addition, when the above material for a protective garment is used on a protective garment, trouble such as releasing the activated carbon fibers from the activated carbon fiber sheet 11, rarely occurs.

It is easy to reduce the weight of the above activated carbon fiber sheet and, in addition, the activated carbon fiber sheet offers great flexibility, compared to the sheet of the granular activated carbon. Therefore, the protective garment using the above material for a protective garment gives better comfort when worn.

In regard to the method of producing the material for a protective garment of the present invention, the process thereof is simple, compared to the method of producing the activated carbon fiber sheet in the related art, in which obtain spun yarn from precursor fibers and process into a sheet shape (woven fabric or other kind of fabric), then, carbonize and activate the processed products. In addition, since the activated carbon fiber sheet is sheet-formed after processed to the activated carbon fiber in advance, the processing cost is low. Therefore, the obtained material for a protective garment is cheap and the price of the protective garment can be reduced.

### EXAMPLES

Hereinafter, specifically, the present invention will be described by Examples. However, the present invention is not limited thereto.

### Example 1

### Manufacturing Activated Carbon Fiber

By carbonizing a bundle of the phenolic resin filaments which has 14 μm average fiber diameter (Kynol (registered trademark) KT-2800 manufactured by Gun Ei Chemical Industry Co., Ltd.) in an electric furnace, ongoingly, introducing water vapor, and activating so that the BET specific surface area becomes 1950±50 m²/g, the activated carbon fiber was obtained. The average fiber diameter of the obtained activated carbon filament was 12 μm.

The BET specific surface area and the yield of the obtained activated carbon filament were measured. The results are shown in Table 1.

The activated carbon fiber was cut so that the average fibers length became 3 mm and chopped activated carbon fiber which became a sheet material was obtained.

(Manufacturing activated carbon fiber sheet)

An activated carbon fiber sheet (1-1) in which the mass ratio of the activated carbon (the activated carbon fiber) used as an adsorption material to para-aramid used as a binder was 70:30 and the areal weight was 150 g/m², was manufactured by the following procedure.

The activated carbon fiber used as adsorption material and a para-aramid pulp used as binder were dispersed in water so that the mass ratio between activated carbon fiber and the binder became 70:30 to prepare the slurry (the solid content concentration 0.2% by mass) at room temperature. The slurry was uniformly spread on a copper net for collection of a papermaking machine, dehydrated, and dried by a hot-air drier, whereby the activated carbon fiber sheet (1-1) was obtained.

The toluene adsorption of the obtained activated carbon fiber sheet (1-1) is shown in Table 2.

(Manufacturing Material for a Protective Garment)

A material for a protective garment (1-2) as the activated carbon fiber sheet reinforced by a polyester filament thread, was manufactured by the following procedure.

A spunlace nonwoven fabric made of polyester (M2028-8T manufactured by TORAY INDUSTRIES, INC., areal weight is 28 g/m²) was superposed on the first face of the activated carbon fiber sheet (1-1) described above as the laminate. The material for a protective garment (1-2) was obtained by interweaving the polyester filament thread (75 denier and 36 filler) onto the laminate using a stitch bonding machine.

When the polyester filament thread was interwoven, the stitch pattern was set to the same way as FIG. 1, the stitch density in a wale direction was set to 18 treads/inch, and the stitch length in a course direction was set to 1.95 mm.

The obtained material for a protective garment (1-2) had enough strength to be handled.

### Example 2

### Manufacturing Activated Carbon Fiber Sheet

An activated carbon fiber sheet (2-1) in which the mass ratio of the activated carbon (the activated carbon fiber:the coconut shell activated carbon=1:1 (mass ratio)) used as an adsorption material to para-aramid pulp used as a binder was 70:30 and the areal weight was 150 g/m², was manufactured by the following procedure.

The activated carbon fiber in the form of chopped fiber manufactured in Example 1, the coconut shell activated carbon (the granular activated carbon, the BET specific surface area is 1550±50 m²/g), and a para-aramid pulp used as a binder were dispersed in water so as to become the mass ratio of 35:35:30 to prepare the slurry (the solid content concentration 0.2% by mass) at room temperature. The slurry was uniformly spread on a copper net for collection of a papermaking machine, dehydrated, and dried by a hot-air drier, whereby the activated carbon fiber sheet (2-1) was obtained.

The toluene adsorption data of the obtained activated carbon fiber sheet (2-1) is shown in Table 2.

(Manufacturing Material for a Protective Garment)

A material for a protective garment (2-2) which was the activated carbon fiber sheet reinforced by the polyester filament thread, was manufactured by the following procedure.

A spunlace nonwoven fabric made of polyester (M2028-8T manufactured by TORAY INDUSTRIES, INC., areal weight is 28 g/m²) was superposed on the first face of the phenolic resin-based activated carbon fiber sheet (2-1) described above as the laminate. The material for a protective garment (2-2) was obtained by interweaving the polyester filament thread (75 denier and 36 filler) onto the laminate using a stitch bonding machine.

When the polyester filament thread was interwoven, the stitch pattern was set to the same way as in FIG. 1, the stitch density in a wale direction was set to 18 treads/inch, and the stitch length in course direction was set to 1.95 mm.

The obtained material for a protective garment (2-2) had enough strength to be handled.

### Comparative Example 1

### Manufacturing Phenolic Resin Fiber-Based Spun Yarn

The phenolic resin fibers which have average fiber diameter 14 μm and average fiber length 70 mm (Kynol KF-0270 manufactured by Gun Ei Chemical Industry Co., Ltd.) were spun using a carding machine and a spinning machine and No. 20 cotton count single spun yarn made of phenolic resin fiber was obtained. In addition, the phenolic resin fiber twisted yarn was obtained by twisting three single spun yarns.

(Manufacturing Activated Carbon Fiber Woven Fabric)

The phenolic resin fiber twisted spun yarn was woven by a rapier type loom which equips dobby apparatus and the 8-leaf-satin, areal weight 300 g/m² phenolic resin fiber woven fabric was obtained.

Next, carbonizing the phenolic resin fiber woven fabric described above in an electric furnace, and ongoingly, introducing water vapor for activation so that the BET specific surface area becomes 1950±50 m²/g, the activated carbon fiber woven fabric was obtained.

The measurement analysis results of the BET specific surface area and the yield of the obtained activated carbon fiber woven fabric are shown in Table 1. In addition, the toluene adsorption of the obtained activated carbon fiber woven fabric is shown in Table 2.

TABLE 1

| | | BET Specific Surface |
|---|---|---|
| | Yield (%) | Area (m²/g) |
| Activated Carbon Fiber of | 18.1 | 1930 |
| Example 1 | | |
| Activated Carbon Fiber Woven | 17.9 | 1970 |
| Fabric of Comparative Example 1 | | |

TABLE 2

| | Toluene Adsorption |
|---|---|
| | Rate (%) |
| Activated Carbon Fiber Sheet (1-1) of | 66.6 |
| Example 1 | |
| Activated Carbon Fiber Sheet (2-1) of | 56.6 |
| Example 2 | |
| Activated Carbon Fiber Woven Fabric of | 66.7 |
| Comparative Example 1 | |

The yield (%) is a ratio of the mass (% by mass) between the activated carbon fiber or the activated carbon fiber woven fabric and the mass of the phenolic resin fiber used to produce the activated carbon fiber or the activated carbon fiber woven fabric.

The BET specific surface area was measured at a temperature of 77K, using a nitrogen gas as an adsorption gas by using 3Flex pore size analyzer manufactured by Micromeritics Japan, G. K.

The toluene adsorption rate is a ratio of the mass (% by mass) of toluene adsorbed to 1 g of the activated carbon in a sample (the activated carbon fiber sheet or the activated carbon fiber woven fabric). The mass of toluene adsorbed to the activated carbon was measured in accordance with the standard of the adsorption in 6.1.2 solvent vapor in JIS K 1474: 2007 (Test methods for activated carbon).

From Table 2, it can be confirmed that, in Examples 1 and 2, the activated carbon fiber sheet which has equal adsorption to the activated carbon fiber woven fabric of Comparative Example 1, was obtained with a simpler step compared to Comparative Example 1.

Hereinbefore, the preferred Examples of the present invention were described; however, the present invention is not limited to these Examples. Additions, omissions, substitutions, and other changes to the configuration can be done within an extent without departing from the effect of the invention. The present invention is not limited to the description described above and is limited only by the scope of claims which are attached.

### DESCRIPTIONS OF SYMBOLS

10 material for a protective garment
11 activated carbon fiber sheet
13 thread
20 material for a protective garment
21 activated carbon fiber sheet
23 fabric
25 laminate
27 thread

1. A method of producing a material for a protective garment provided with an activated carbon fiber sheet, comprising:
a step of sheet-forming an activated carbon fiber sheet using an activated carbon fiber in which a phenolic resin fiber is used as a precursor; and
a step of reinforcing the activated carbon fiber sheet by interweaving a thread onto the activated carbon fiber sheet.

2. A method of producing a material for a protective garment provided with an activated carbon fiber sheet, comprising:
a step of sheet-forming an activated carbon fiber sheet using an activated carbon fiber in which a phenolic resin fiber is used as a precursor; and
a step of reinforcing the activated carbon fiber sheet by superposing fabrics on any one of or both a first face and a second face of the activated carbon fiber sheet as a laminate and interweaving a thread onto the laminate.

3. The method of producing a material for a protective garment according to claim 1,
wherein the average fiber diameter of the activated carbon fiber is from 2 μm to 50 μm and the average fiber length of the activated carbon fiber is from 1 mm to 100 mm.

4. The method of producing a material for a protective garment according to claim 2,
wherein the average fiber diameter of the activated carbon fiber is from 2 μm to 50 μm and the average fiber length of the activated carbon fiber is from 1 mm to 100 mm.

5. A material for a protective garment produced by the method of producing a material for a protective garment according to claim 1.

6. A material for a protective garment produced by the method of producing a material for a protective garment according to claim 2.

7. A protective garment using the material for a protective garment according to claim 5.

8. A protective garment using the material for a protective garment according to claim 6.
